(19) United States
(12) Patent Application Publication
(10) Pub. No.: US 2006/0229151 A1
(43) Pub. Date: Oct. 12, 2006

(54) Linear tensioner

(76) Inventors: Christian Jansen, Ontario (CA); John Antchak, Ontario (CA); Bert Mevissen, Ontario (CA)

Correspondence Address: Robin W Asher;Clark Hill, 500 Woodward Avenue, Suite 3500, Detroit, MI, 48226-3435, US

(21) Appl. No.: 10/554,562

(22) PCT Filed: May 6, 2004
(86) PCT No.: PCT/CA04/00667

§ 371 Date: Oct. 25, 2005

Related U.S. Application Data
(60) Provisional application No. 60/468,394, filed on May 6, 2003.
(60) Provisional application No. 60/490,140, filed on Jul. 25, 2003.

(51) Int. Cl. F16H 7/14; F16H 7/12; F16H 7/08

(52) U.S. Cl. 474/117; 474/133; 474/138; 474/101

(57) ABSTRACT

A linear tensioner has a longitudinally extending first sleeve having an end configured for pivotal coupling and a longitudinally extending second sleeve having an end configured for pivotal coupling. The second sleeve slidably receives the first sleeve and frictionally engages therewith. A biasing member extends between and is housed by the sleeves and urges the sleeves apart. The first sleeve operatively engages with the second sleeve enabling sliding movement within a range and retains the sleeves together against the bias of the biasing member.

### FIELD OF THE INVENTION

The invention relates to a linear tensioner for tensioning a serpentine belt of an automobile engine. More particularly, the invention relates to a mechanical linear tensioner.

### DESCRIPTION OF THE RELATED ART

Linear tensioners are commonly used to continuously tension a serpentine belt of an automobile engine. Typically, a linear tensioner includes a hydraulic or pneumatic cylinder. Conventional linear tensioners are utilized when there is insufficient space on an engine for a rotary tensioner.

Linear tensioner assemblies typically comprise a carrier plate pivotally mounted to the engine of the vehicle for carrier a tensioner pulley. The serpentine belt is wound around the tensioner pulley. The linear tensioner is coupled between the carrier plate opposite the tensioner pulley and the engine to provide constant tension on the serpentine belt.

Hydraulic or pneumatic tensioners suffer from a phenomenon know as “pump up”. The tensioner will build up pressure in response to the vibrations of the belt and will not release this pressure. The tensioner has a tendency to over-tensioner the belt and thus reduce the lifespan of the belt.

Other mechanical linear tensioners are shown in the prior art. Such tensioners are shown in U.S. Pat. No. 6,422,964. However, such tensioners require a pin to hold the tensioner together during shipping and must be removed after the belt has been applied over the pulley.

### SUMMARY OF THE INVENTION

It is desirable to provide a linear tensioner that does not over-tension the serpentine belt.

It is desirable to provide a linear tensioner comprising a first sleeve and a second sleeve slidably received within one another to house a biasing spring that urges the sleeves apart. The first sleeve and the second sleeve have a connection therebetween that limits the sliding movement against the bias of the biasing member, retaining the first sleeve within the second sleeve.

According to one aspect of the invention, a linear tensioner has a longitudinally extending first sleeve having an end configured for pivotal coupling and a longitudinally extending second sleeve having an end configured for pivotal coupling. The second sleeve slidably receives the first sleeve and frictionally engages therewith. A biasing member extends between the sleeves and urges the sleeves apart. The first sleeve operatively engages with the second sleeve enabling sliding movement within a range and retains the sleeves together against the bias of the biasing member.

According to another aspect of the invention, the linear tensioner has sleeves that are coupled together in a bayonet fashion.

### BRIEF DESCRIPTION OF THE DRAWINGS

Advantages of the present invention will be readily appreciated as the same becomes better understood by reference to the following detailed description when considered in connection with the accompanying drawings, wherein:

FIG. 1 is a front view of an automobile engine incorporating a linear tensioner according to one embodiment of the invention;

FIG. 2 is a partially exploded perspective view of the linear tensioner;

FIG. 3 is a cross sectional view of the linear tensioner;

FIG. 4 is an exploded side view of a second embodiment of the linear tensioner;

FIG. 5 is a cross sectional view of the second embodiment of the linear tensioner;

FIG. 6 is a perspective view of a third embodiment of the linear tensioner;

FIG. 7 is a cross sectional view of the third embodiment of the linear tensioner;

FIG. 8 is a perspective view of a fourth embodiment of the linear tensioner;

FIG. 9 is a cross sectional view of the fourth embodiment of the linear tensioner;

FIG. 10 is a perspective view of a fifth embodiment of the linear tensioner;

FIG. 11 is a cross sectional view of the fifth embodiment of the linear tensioner;

FIG. 12 is a perspective view of a sixth embodiment of the linear tensioner;

FIG. 13 is a cross sectional view of the sixth embodiment of the linear tensioner;

FIG. 14 is a perspective view of a seventh embodiment of the linear tensioner;

FIG. 15 is a cross sectional view of the seventh embodiment of the linear tensioner;

FIG. 16 is a cross sectional view of an eighth embodiment of the linear tensioner;

FIG. 17 is a partially exploded perspective view of a ninth embodiment of the linear tensioner;

FIG. 18 is a perspective view of the ninth embodiment of the linear tensioner;

FIG. 19 is a cross sectional view of the ninth embodiment of the linear tensioner;

FIG. 20 is another cross sectional view of the ninth embodiment of the linear tensioner;

FIG. 21 is a perspective view of a tenth embodiment of the linear tensioner;

FIG. 22 is a cross sectional view of a tenth embodiment of the linear tensioner; and

FIG. 23 is another cross sectional view of a tenth embodiment of the linear tensioner.

### DETAILED DESCRIPTION OF THE PREFERRED EMBODIMENTS

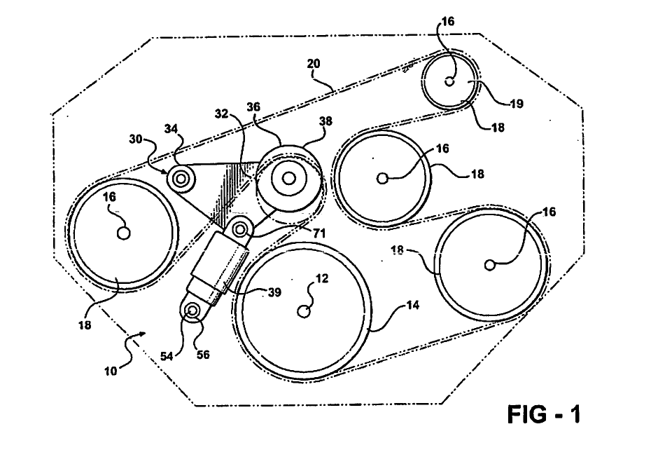

Referring to FIG. 1, an engine for an automotive vehicle is generally indicated at 10. A crank sleeve 12 is rotatably driven by torque provided by the engine 10. A crank pulley 14 is fixedly secured to the crank sleeve 12. The engine 10 also includes a plurality of engine driven accessories, such as an alternator or water pump. Each of the engine driven accessories includes a rotatable input sleeve 16 and an input pulley 18 fixedly secured thereto. Each of the engine driven accessories is driven by the rotation of the input sleeve 16. A serpentine belt 20 is wrapped around the crank pulley 14 and the input pulleys 18. The belt 20 delivers the torque provided by the engine 10 from the crank pulley 14 to the input pulleys 18. The belt 20 converts rotational movement of the crank pulley 14 into rotational movement of the input pulleys 18. Described in detail below, a tensioner assembly 30 keeps the belt 20 in tension to prevent slippage of the belt 20 relative to the crank 14 and input 18 pulleys.

The tensioner assembly 30 includes a carrier plate 32. A first pivot assembly 34 pivotally interconnects the carrier plate 32 to the engine 10. The first pivot assembly 34 includes a collar forming an aperture through the carrier plate 32 for supporting a bushing and plurality of dampening washers. A mounting bolt is inserted through each of the bushing, washers and aperture to pivotally secure the tensioner assembly 30 to the engine 10 and the washers provide dampening to quell vibratory oscillations occurring in the belt 20. The pivot assembly 34 is more fully described in Applicant's German patent no. 10053186.

A tensioner pulley 36 is rotatably coupled to the carrier plate 32 by a second pin 38 spaced opposite the first pivot assembly 34. The belt 20 is wrapped around the tensioner pulley 36. The tensioner pulley 36 pivots with the plate 32 about the first pivot assembly 34. When the carrier plate 32 pivots in the counterclockwise direction, as viewed in FIG. 1, the tensioner pulley 36 presses into the belt 20 to increase the tension of the belt 20. When the carrier plate 32 pivots in the clockwise direction, the tensioner pulley 36 moves away from the belt 20 to decrease tension in the belt 20.

Linear tensioners disclosed as various embodiments of the present invention include friction strut or sleeve designs capable of providing symmetrically damped, asymmetrically damped, and/or un-damped forces. Symmetric damping is generated by the sliding interface between the sleeve and sleeve of the linear tensioner and is independent of the direction of movement of the components. Asymmetric damping is achieved, again by the frictional interface of the sleeve and sleeve, but the damping forces are dependant on the direction of movement of the components. Generally the damping forces are greater for compressive movements than for extensions of the sleeve. Un-damped linear tensioners of the present invention have a minimal frictional engagement between the sleeve and sleeve. The sleeve and sleeve function to guide the compression of a spring disposed within the sleeve and sleeve. Typically, a damping pack or accessory may be included in un-damped embodiments and can be located at the pivot where the linear tensioner attaches to an engine, as discussed above with respect to the first pivot assembly 34, and will be discussed in more detail below.

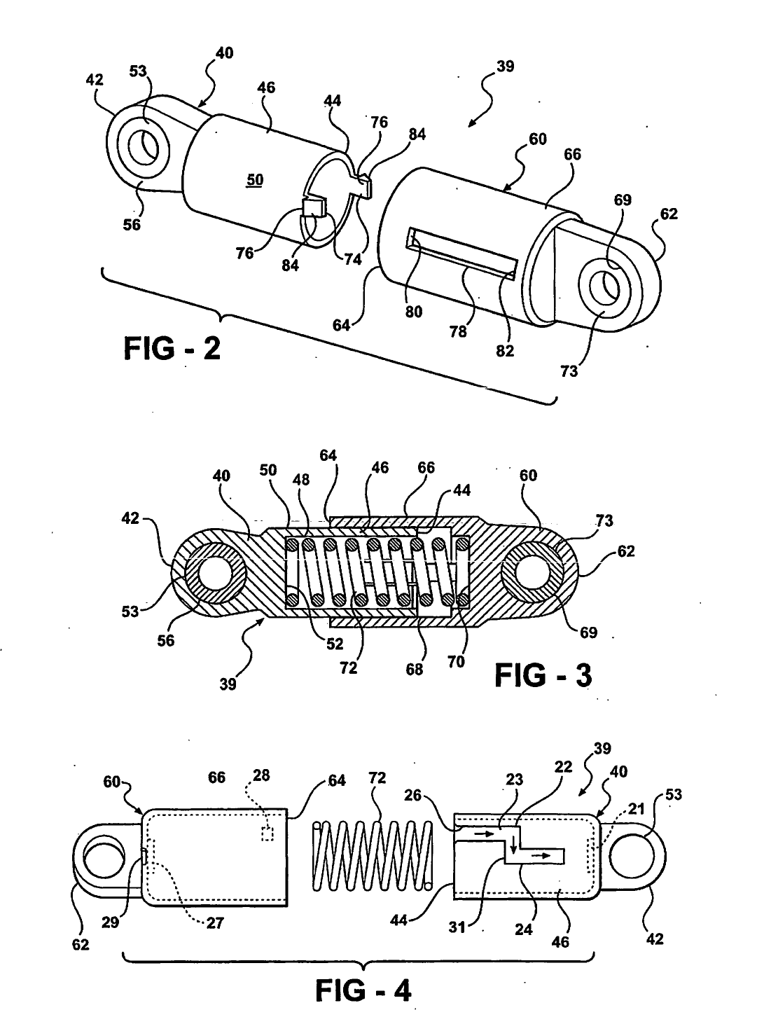

Referring to FIGS. 2 and 3, a linear tensioner is generally indicated at 39. The linear tensioner 39 includes a first sleeve 40 that extends between a proximal end 42 and a distal end 44. The sleeve 40 is preferably cast or machined aluminum. The sleeve 40 includes a tubular body 46 that extends between the proximal 42 and distal 44 ends. The body 46 includes generally cylindrical inner 48 and outer 50 surfaces. The inner surface 48 extends between a first or inner abutment surface 52 and the distal end 44. A pivot aperture or eye 53 is formed at the proximal end 42 for seating a first bushing 56 therein.

The bushing is preferably a pushed in or press fit metal DU type of bushing. However, a sliding fit foil type of bushing, a spray on or dipped type of bushing, or a rubber eyelet type of bushing may be used.

A third pin 54 extends through the bushing 56 and pivotally interconnects the proximal end 42 of the sleeve 40 to the engine 10. Alternatively, the proximal end 42 of the sleeve 40 may be attached to the engine 10 by any suitable fastener, such as, a bolt, snap fit connection, ball and socket connection, or the like, as are commonly known connector to one of ordinary skill in the art.

The linear tensioner 39 also includes a second sleeve 60 extending between a proximal end 62 and a distal end 64. The second sleeve 60 is preferably molded plastic. The sleeve 60 includes a generally cylindrical body 66 that extends between the proximal 62 and distal 64 ends. The sleeve body 66 includes a generally cylindrical inner surface 68 that extends between a second inner abutment surface 70 and the distal end 64 of the sleeve 60. A pivot aperture or eye 69 is formed in the sleeve body 66 adjacent the proximal end 62 for seating a second bushing 73 therein.

A fourth pin 71 extends through the bushing 73 and pivotally interconnects the proximal end 62 of the sleeve to the plate 32.

The outer surface 50 of the body 46 is slidably received within the inner surface 68 of the sleeve 60. The outer surface 50 of the body 46 and the inner surface 68 of the sleeve 60 are sized to create a predetermined amount of friction. The friction dampens the movement of the sleeve 60 relative to the sleeve 40 in a generally symmetrical manner, wherein the amount of dampening is consistent during both compression and extension of the linear tensioner 39.

A biasing member 72, preferably a helical coil spring, is housed within the sleeves 40 and 60 and continuously compressed between first 52 and second 70 abutment surfaces, such that the sleeve 40 and the sleeve 60 are axially biased apart. The axial bias of the sleeve 60 relative to the sleeve 40 rotatably biases the plate 32 in the counterclockwise direction, which, in turn, tensions the belt 20.

The sleeves 40 and 60 have an interconnection that enables sliding movement therebetween and holds the two sleeves together against the bias of the biasing member 72. The interconnection generally comprises a projection slidably engaging a slot. The slot defines a range of sliding movement, with one end defining a limit The range of sliding movement includes a working or operation range of movement. The slots 78 have a length that defines the range of sliding movement that is greater than the expected working range of the tensioner 39.

In the first preferred embodiment, the interconnection is a pair of projections or flexible fingers 74 formed along diametrically opposed sides of the body 46 of sleeve 40. The tip of the flexible fingers 74 is defined by a tang 76. A ramped surface 84 is formed in each tang 76 to facilitate ingress of the body 46 into the sleeve body 66, while preventing egress.

The sleeve 60 includes a corresponding pair of elongated slots 78 extending between first 80 and second 82 ends formed in the sleeve body 66 that correspond to the tangs 76. Each of the tangs 76 projects through the corresponding slot 78 and is slidably engaged therein. The tangs 76 limit the travel of the sleeve 60 away from sleeve 40.

During insertion of the body 46 into the sleeve body 66, the ramped surface 84 engages the distal end 64 of the sleeve 60. The engagement of the ramped surface 84 with the distal end 64 of the sleeve 60 elastically deforms the fingers 74 and inwardly displaces the tang 76 until the tang 76 slidably engages the slot 78. The sliding movement of the tangs 76 within the slots 78 is constrained by the first 80 and second 82 ends of the slots 78, which defines the range of axial movement of the sleeve 60 relative to the sleeve 40. The locking connection between the tangs 76 and slots 78 slidably couple the sleeve 40 to the sleeve 60, with the spring 72 compressed therebetween so that the tensioner assembly 30 may be assembled, stored, shipped and/or assembled to the vehicle engine as a pre-assembled component

An un-damped version of the first embodiment can be utilized by minimizing the frictional engagement of the sleeve 40 with the sleeve 60, with the other components remaining unchanged.

The first embodiment of the linear tensioner 39 may be utilized in a front end accessory drive system that includes an overrunning decoupler 19, as best seen in FIG. 1. The overrunning decoupler 19 is typically associated with an alternator, due to its large effect on the tension within the belt 20 because of its high inertia. The overrunning decoupler 19 reduces the dynamic tensions within the belt 20 providing an overall system requiring lower damping forces.

An overrunning decoupler in its simplest form includes a belt engaging member operatively connected to a hub structure by a resilient member and a one way clutch connected to each other. The one way clutch and resilient member preferably comprise a helical spring assembly. Acceleration and rotation of the pulley in the driven direction relative to the hub creates friction between the inner peripheral surface of the pulley and preferably all of the coils of the clutch spring. The clutch spring is helically coiled such that the friction between the inner peripheral surface of the pulley and at least one of the coils would cause the clutch spring to expand radially outwardly toward and grip the inner peripheral surface. Continued rotation of the pulley in the driven direction relative to the hub would cause a generally exponential increase in the outwardly radial force applied by the coils against the inner peripheral surface until all of the coils of the clutch spring become fully brakingly engaged with the pulley. When the pulley decelerates, the hub driven by the inertia associated with the rotating drive sleeve and the rotating mass within the alternator will initially “overrun” or continue to rotate in the driven direction at a higher speed than the pulley. More specifically, the higher rotational speed of the hub relative to the pulley causes the clutch spring to contract radially relative to the inner peripheral surface. The braking engagement between the clutch spring and the pulley is relieved, thereby allowing overrunning of the hub and drive sleeve from the alternator relative to the pulley. A preferred decoupler design is described in Applicant's U.S. Pat. No. 6,083,130 and is commonly assigned to the assignee of the present invention. All of the embodiments of the linear tensioner described above and below can be utilized in a front end accessory drive system including an overrunning decoupler 19.

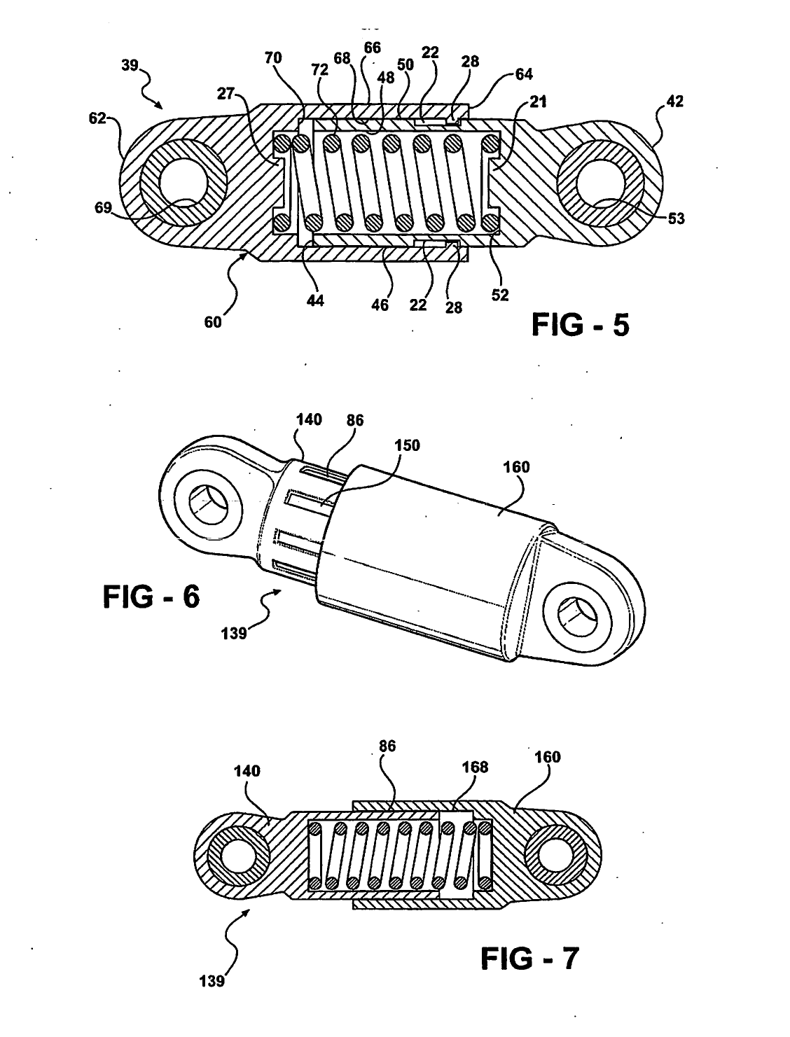

Referring to FIGS. 4 and 5, a second embodiment of the linear tensioner 39 is shown. The sleeve 40 and sleeve 60 of the linear tensioner 39 of the second embodiment are slidably coupled by a bayonet-type locking connection therebetween. Specifically, the linear tensioner 39 similarly includes a sleeve 40 extending between proximal 42 and distal 44 ends. A cylindrical body 46 is defined by inner 48 and outer 50 surfaces. The inner surface 48 extends between a first abutment surface 52 and the distal end 44. An aperture 53 extends through the proximal end 42 for attaching the sleeve 40 to the carrier plate 32. A hub 21 projects axially from the first abutment surface 52 for seating one end of a biasing member 72 within the body 46. An offset locking slot 22 is recessed into the outer surface 50 of the body 46 and extends axially from the distal end 44 toward the proximal end 46. The offset locking slot 22 includes a first linear portion 23 and a generally parallel second linear portion 24 offset radially from the first linear portion 23. The first and second linear portions 23, 24 are interconnected by a third portion 25 extending circumferentially and generally perpendicularly therebetween. The first linear portion 23 has a flared entry 26 adjacent the distal end 44 of the body 46.

The linear tensioner 39 of the second embodiment of FIGS. 4 and 5 further includes a sleeve 60 extending between proximal 62 and distal 64 ends. A cylindrical sleeve body 66 includes an inner surface 60 that extends between a second abutment surface 70 and the distal end of the sleeve 60. An aperture 69 extends through the proximal end 62 for attaching the sleeve 60 to the engine 10. A hub 27 projects axially from the second abutment surface 70 for seating the opposite end of a biasing member 72 within the sleeve body 66. A pair of guide tabs 28 projects radially inwardly from opposing sides of the inner surface 68 of the sleeve body 66 adjacent the distal end 64 thereof. A pair of openings 29 extend through the inner surface 68 along opposite sides of the sleeve body 66 adjacent the proximal end 62 thereof for allowing air to escape from within the body 46.

In assembly, the sleeve 40 and sleeve 60 are slidably and rotatably connected by the bayonet locking connection. The biasing member 72 is positioned between the sleeve 40 and sleeve 60 and aligned for opposing ends thereof to be seated about the hubs 21, 27, respectively, and compressed therebetween. The guide tabs 28 are axially and radially aligned with the flared entry 26 of the first linear portion 23 of each respective offset locking slot 22. The sleeve 40 and sleeve 60 compress the biasing member 72 axially therebetween as the tabs 28 slide axially along the first linear grooves 23 and into the third groove 25. The sleeve 40 is then rotated relative to the sleeve 60 to translate the tabs 28 along the third portion 25 into the second linear portion 24. After rotation, the compressed biasing member 72 maintains the tabs 28 between first and second end walls 31, 33 of the second linear portion 24, thus coupling the sleeve 40 and sleeve 60, and defining the range of longitudinal movement of the sleeve 60 relative to the sleeve 40. Any air that may be trapped and compressed between the sleeve 40 and sleeve 60 may escape through the openings 29 in the sleeve 60.

Referring to FIGS. 6 and 7, a third embodiment of the linear tensioner 139 is shown, wherein elements of the alternative embodiment similar to those in the first and second embodiments are indicated by reference characters that are offset by 100. At least one, but preferably a plurality of longitudinally extending slots or grooves 86 is integrally formed in the outer surface 150 of the sleeve 140. The inner surface 168 of the sleeve 160 has a series of corresponding pads 87. The pads 87 slide within the grooves 86. The end of groove 86 limits the extent to which the sleeves 140 and 160 may travel away from each other. The raised pads 87 provide for the control of thermal expansion while further providing a discharge path therebetween for contaminants that have entered the linear tensioner 139.

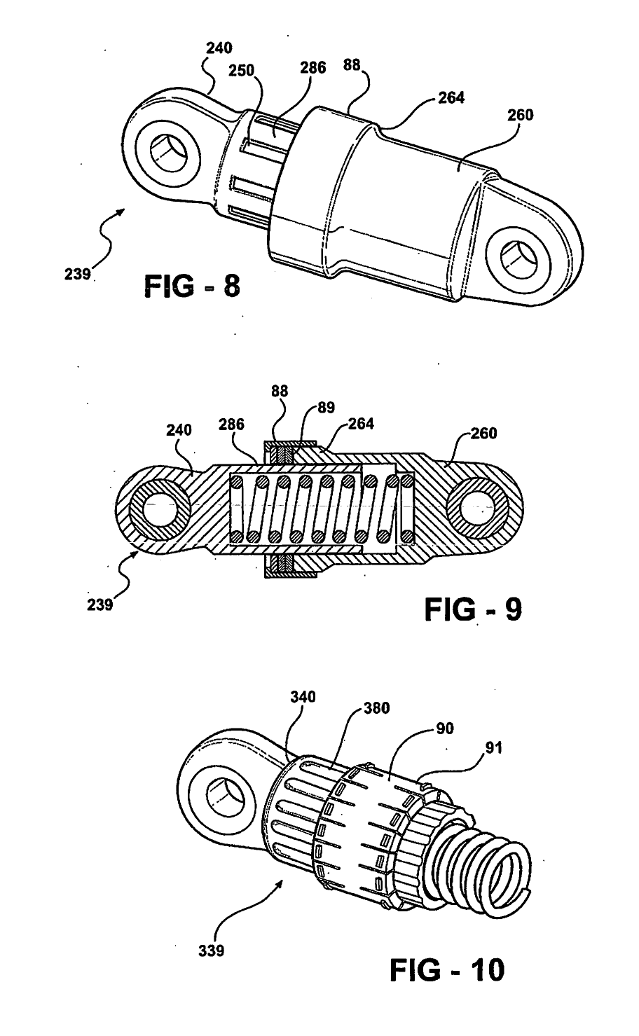

Referring to FIGS. 8 and 9, a fourth embodiment of the linear tensioner is generally indicated at 239. A retaining ring 88 is fixedly secured to the distal end 264 of the sleeve 260. At least one spring washer 89 is supported between the retaining ring 88 and the sleeve 260 for frictionally engaging the outer surface 250 or pads 286 of the sleeve 240. The friction between the spring washer 89 and the outer surface 250 or pads 286 dampens the sliding movement of the sleeve 260 relative to the sleeve 240. Preferably, the spring washer 89 is conical to provide asymmetrical or isometric dampening, wherein the friction is greater, for example, during compression of the linear tensioner 239 than during extension.

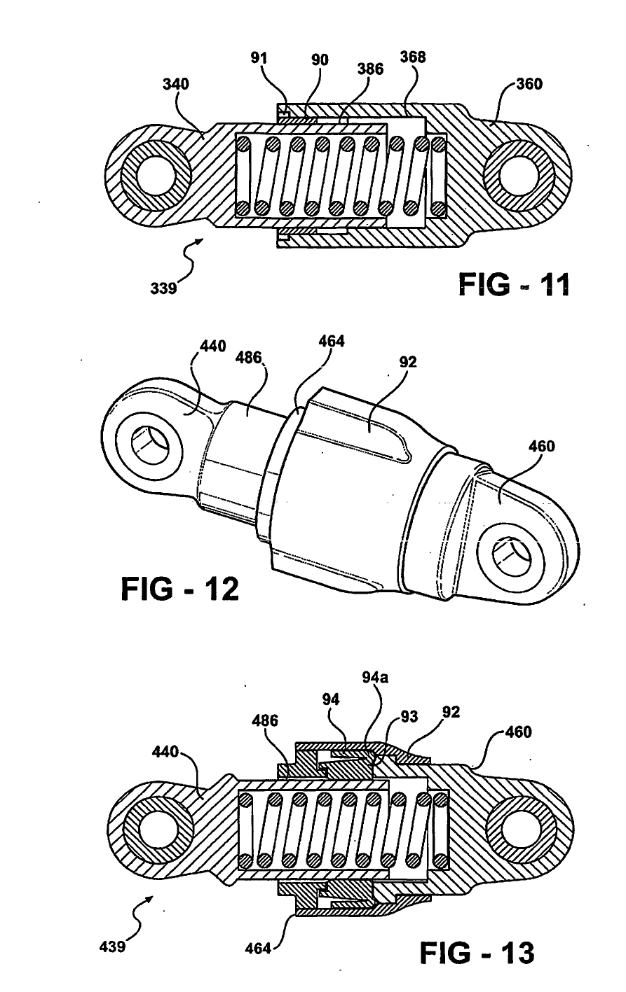

Referring to FIGS. 10 and 11, a fifth embodiment of the linear tensioner is generally indicated at 339. A sleeve 90 is coupled between the outer surface 350 of the sleeve 340 and the inner surface 368 of the sleeve 360. The sleeve 90 includes at least one, but preferably a plurality of fingers 91. Each of the plurality of fingers 91 extends outwardly at an angle relative to the axis of the sleeve 340, such that each of the plurality of fingers 91 frictionally engages the inner surface 368 of the sleeve 360 during compression of the linear tensioner 339. The frictional engagement of the plurality of fingers 91 with the inner surface 368 of the sleeve 360 tends to deflect or bend the plurality of fingers 91 until each are generally normal to the axis of the sleeve 340. Thee deflection of the plurality of fingers 91 pushes the sleeve 90 radially inwardly relative to the outer surface 350 or pads 386 of the sleeve 340, which increases the frictional force and dampens the movement of the sleeve 360 relative to the sleeve 340.

Referring to FIGS. 12 and 13, a sixth embodiment of the linear tensioner is generally indicated at 439. The linear tensioner 439 includes a retaining sleeve 92 that is fixedly secured to the distal end 464 of the sleeve 460. At least one sprag 93 is coupled between the retaining sleeve 92 and the outer surface 350 of the sleeve 340. The sprag 93 includes a spring tab 94 that pivotally biases the sprag 93 about a fulcrum point 94a. The spring tab 94 pushes the sprag 93 away from the retaining sleeve 92 and into frictional engagement with the outer surface 350 of the sleeve 340. The frictional engagement between the sprag 93 and the outer surface 350 or pads 386 of the sleeve 340 dampens the compression and the extension of the linear tensioner 439. The frictional engagement between the sprag 93 and the outer surface 350 or pads 386 is greater during compression of the linear tensioner 439 than during extension due to the pivotal bias of the sprag 93 about the fulcrum point 94a.

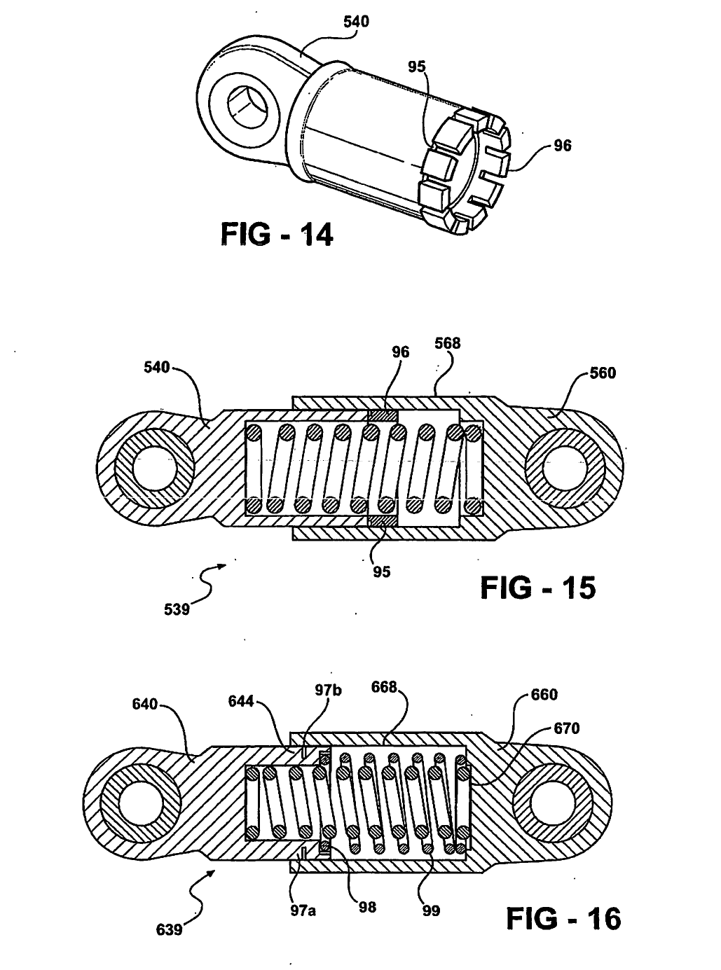

Referring to FIGS. 14 and 15, a seventh embodiment of the linear tensioner is generally indicated at 539. A sprag ring 95 is fixedly secured to the distal end 544 of the sleeve 540. At least one, but preferably a plurality of spaced apart sprag members 96 is integrally formed on the sprag ring 95. During assembly of the sleeve 540 and the sleeve 560, the plurality of sprag members 96 are displaced inwardly relative to the inner surface 568 of the sleeve 560. The inward displacement of the sprag members 96 torsionally preloads the sprag ring 95, such that the plurality of sprag members 96 are continuously biased into frictional engagement with the inner surface 568 of the sleeve 560. The frictional engagement of the plurality of sprag members 96 and the inner surface 568 of the sleeve 560 dampens the compression of the linear tensioner 539.

Referring to FIG. 16, an eighth embodiment of the linear tensioner is generally indicated at 639. A plurality of sprag members 97 is integrally formed at the distal end 644 of the sleeve 640 and pivotally secured thereto by a living hinge connection at 97a created by a notch 97b cut in the sleeve 640. Each of the plurality of sprag members 97 includes a step surface 98. A second biasing member 99, preferably in the form of a helical coil spring, is compressed between the step surfaces 98 and the second abutment surface 670 of the sleeve 660. The second biasing member 99 biases the plurality of sprag members 97 toward frictional engagement with the inner surface 668 of the sleeve 660. The frictional engagement between the plurality of sprag members 97 and the inner surface 668 of the sleeve 660 dampens the compression and extension of the linear tensioner 639.

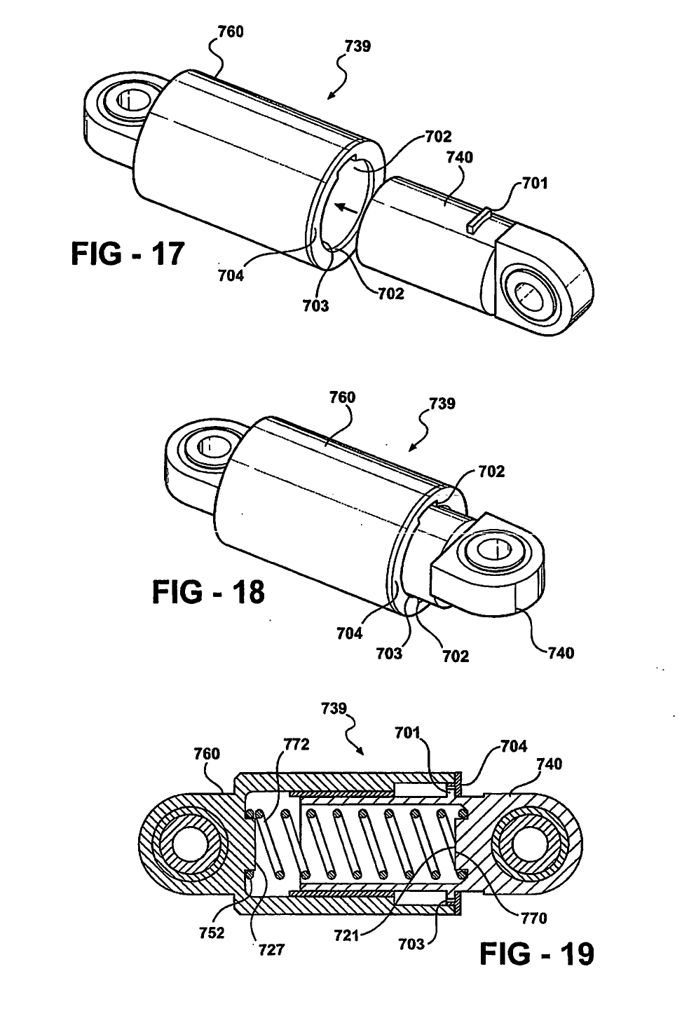

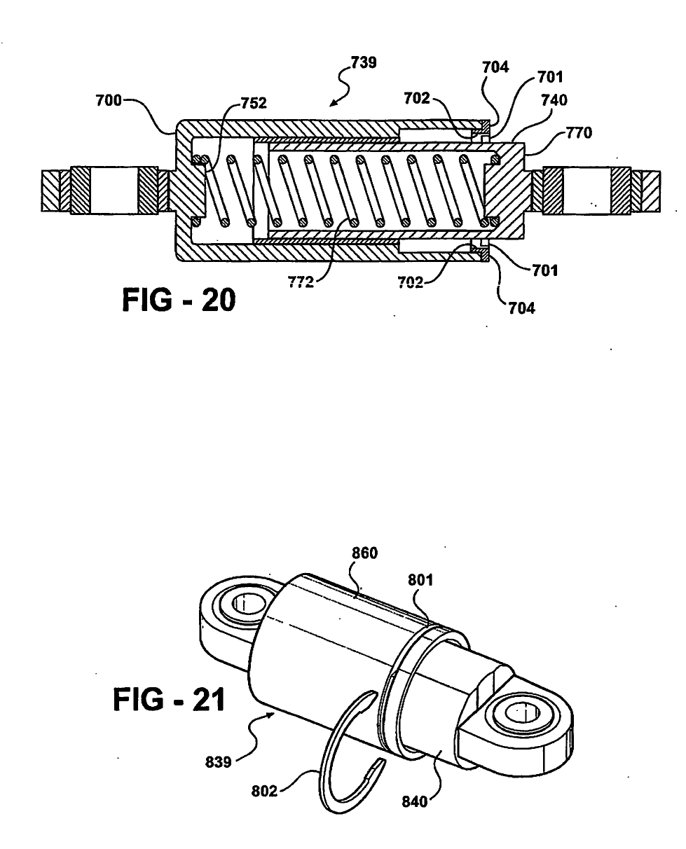

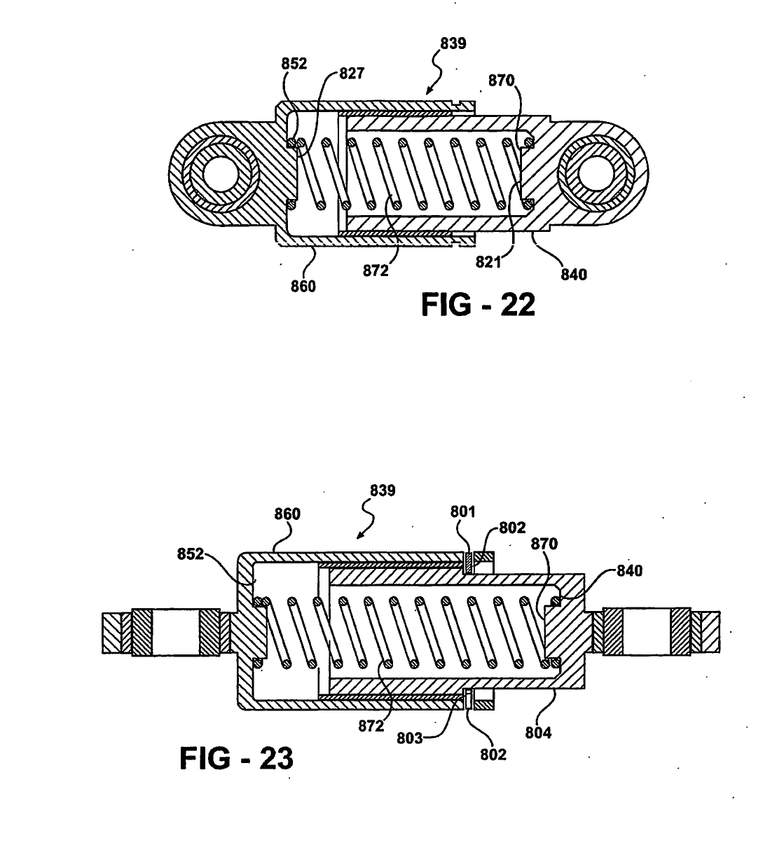

Referring to FIGS. 17-23, there will be described un-damped embodiments of the linear tensioner of the present invention.

Referring to FIGS. 17-20, there is shown a ninth embodiment of the linear tensioner 739 of the present invention. As this embodiment is un-damped, the sleeve 740 and sleeve 760 have minimal frictional engagement. As with the previously described embodiments, a biasing member or spring (not shown) is continuously compressed between first 752 and second 770 abutment surfaces, such that the sleeve 740 and sleeve 760 are axially biased apart.

The ninth embodiment includes an alternative attachment for coupling the sleeve 740 with the sleeve 760. The sleeve 740 includes a bayonet projection 701 extending radially from the sleeve 740. The bayonet projection 701 is received in a keyed slot 702 formed in an end cap 704 on the distal end of the sleeve 760. The bayonet projection 701 on the sleeve 740 is aligned with the keyed slot 702, as shown in FIG. 17 and then moved longitudinally within the sleeve 760 and turned radially to abut an engaging surface 703 defined by the inner surface of the end cap 704 of the sleeve 760, as shown in FIG. 18. In this manner the sleeve 740 is maintained within the sleeve 760. It is to be understood that any of the attachments described can be utilized by any of the other embodiments discussed in the application, including damped versions of the linear tensioner. The bayonet projection 701 described with the un-damped embodiment is done for the sake of clarity and avoiding repetitive descriptions for both the damped and un-damped versions of a linear tensioner.

Referring to FIGS. 21-23, there is shown a tenth embodiment of the linear tensioner 839 of the present invention. As with the previous embodiment, the tenth embodiment is un-damped having the sleeve 840 and the sleeve 860 in minimal frictional engagement. As with the prior embodiments, a biasing member or spring (not shown) is continuously compressed between first 852 and second 870 abutment surfaces, such that the sleeve 840 and sleeve 860 are axially biased apart.

The alternative attachment of the tenth embodiment for coupling the sleeve 840 with the sleeve 860 comprises a slot 801 formed circumferentially through the sleeve 860 in which a C-shaped snap ring 802 is introduced. The sleeve 840 is placed within the sleeve 860 and then the snap ring 802 is introduced into the slot 801 to engage a surface 803 formed by a stepped down notched outer surface 804 in the sleeve 840 to maintain it within the sleeve 860. As with the above described embodiments, the snap ring 802 version of attachment may be used by any of the previously described embodiments, including damped versions of the linear tensioner.

The damping characteristics of the tensioner assembly may varying and are specific to the particular engine, accessory loads and engine torsionals. The damping may be provide by the washers of the first pivot assembly 34, friction between the sleeve 40 and sleeve 60, damping losses within the spring 72 as it is compress and extended and/or friction due to the rotational movement between the pivot bushings 56, 73 and mounting bolts, as well as, the above-described embodiments of the invention.

The invention has been described in an illustrative manner, and it is to be understood that the terminology, which has been used, is intended to be in the nature of words of description rather than of limitation. Many modification and variations of the present invention are possible in light of the above teachings. It is, therefore, to be understood that within the scope of the appended claims, the invention may be practiced other than as specifically described.

What is claimed is:

1. A linear tensioner adapted to be coupled between an engine and a tensioner pulley for tensioning a serpentine belt of an automobile engine, said linear tensioner comprising:
a longitudinally extending first sleeve having an end configured for pivotal coupling;
a longitudinally extending second sleeve having an end configured for pivotal coupling, said second sleeve slidably receiving said first sleeve and frictionally engaging therewith; and
a biasing member extending between said sleeves, urging said sleeves apart;
said first sleeve operatively engaging with the second sleeve enabling sliding movement within a range greater than a working range of said linear tensioner and retaining the sleeves together against the bias of the biasing member.

2. A linear tensioner as set forth in claim 1 wherein said operative engagement comprises one of said first and second sleeves having at least one projection and the other of said first and second sleeves having at least one corresponding elongated slot receiving a respective one of said at least one projection therein, said at least one projection abutting an end of said slot limiting said sliding movement against the bias of the biasing member.

3. A linear tensioner as set forth in claim 2 wherein said projection has a tang that is biased enabling ingress of the first sleeve within the second sleeve and preventing egress therefrom.

4. A linear tensioner as set forth in claim 3 wherein said tang is at a distal end of resilient fingers.

5. A linear tensioner as set forth in claim 2 wherein said slot has a first portion, a second portion extending generally parallel and circumferentially offset from said first portion, and a third portion extending circumferentially between and interconnecting said first and second portion.

6. A linear tensioner as set forth in claim 5 wherein said first linear portion includes a flared entry for aligning said projection with the first portion.

7. A linear tensioner as set forth in claim 6 further including a pair of tabs spaced along opposing sides of said inner surface of said sleeve and a pair of offset locking slots formed in said outer surface of said sleeve for slidably and lockingly receiving said respective pair of tabs therein.

8. A linear tensioner as set forth in claim 1 wherein said operative engagement comprises at least one projection protruding from one of said sleeves and an end cap secured to the other of said sleeves, said end cap having at least one corresponding keyed slot therein for receiving said at least one projection therethrough upon sliding insertion of said first sleeve into said second sleeve wherein once said at least one projection is passed through said corresponding keyed slot, said sleeves are rotated engaging said at least one projection against said end cap.

9. A linear tensioner as set forth in claim 1 wherein said operative engagement comprises one of said sleeves having an abutment and the other of said sleeves has a circumferentially extending slot, and a snap ring seated within said slot engaging with said abutment, preventing said sleeves from separating.

10. A linear tensioner as set forth in any preceding claim further including a retaining ring fixedly secured to one of said sleeves and at least one spring washer supported between said retaining ring and said sleeve, said spring washer frictionally engaging the other of said sleeves to dampen said sliding movement therebetween.

11. A linear tensioner as set forth in claim 10 further including a retaining ring fixedly secured to one of said sleeves and at least one sprag coupled between said retaining ring and said one of said sleeves, said sprag comprising a spring tab compressed against said retaining ring for biasing said sprag into frictional engagement against the other of said sleeves to dampen said sliding movement.

12. A linear tensioner as set forth in claim 11 further including a plurality of flexible sprags extending longitudinally from an end of one of said sleeves and biased radially outwardly into frictional engagement with the other of said sleeves for damping said sliding movement therebetween.

13. A linear tensioner as set forth in claim 12 wherein said sprags are integrally formed, said one of said sleeves including a notch in said outer surface thereof to form a living hinge enabling pivotal movement of said sprag and said tensioner further comprises a second biasing member urging said sprag into engagement with the other of said sleeves.

14. A linear tensioner as set forth in any of claims 1 to 9 wherein each of said sleeves has an eye enabling pivotal coupling.

15. A linear tensioner as set forth in claim 14 wherein a bushing is seated within each of said eyes.

16. A tensioner assembly comprising a base plate having a first pivotal connection for mounting the base plate to an engine, a pulley pivotally mounted to said base plate and a linear tensioner according to any one of the preceding claims, wherein one of said sleeves is pivotally connected to the base plate and the other of the sleeves is pivotally connectable to the engine.
